(19) United States
(12) Patent Application Publication
(10) Pub. No.: US 2011/0179960 A1
(43) Pub. Date: Jul. 28, 2011

(54) METHOD AND APPARATUS FOR PRINTING ONTO ELONGATED HOLLOW OR SOLID SUBSTRATES

(75) Inventors: Donald J. Sandow, II, Tolland, CT (US); Joseph A. Tetrault, Stafford Springs, CT (US); Warren K. Smith, III, Charleston, SC (US); Roger M. Harvey, Novi, MI (US)

(73) Assignee: ILLINOIS TOOL WORKS INC., Glenview, IL (US)

(21) Appl. No.: 13/005,396

(22) Filed: Jan. 12, 2011

Related U.S. Application Data
(60) Provisional application No. 61/298,516, filed on Jan. 26, 2010.

(51) Int. Cl. B41F 5/00

(52) U.S. Cl. 101/216; 101/483

(57) ABSTRACT

An apparatus for printing on elongated substrates along a length of the substrate includes an infeed control assembly for the substrate, an outfeed control assembly for the substrate and a heat transfer applicator to transfer a graphic from the tape onto the substrate. The infeed control assembly includes a set of infeed rollers and a guide with adjustable tension control. The outfeed control assembly includes a set of outfeed rollers and a guide with adjustable tension control. The heat transfer applicator is a set of wheels, at least one of which has a circumferential recess on an edge thereof to accommodate the elongated tubular substrate. A method for printing on the elongated substrate includes feeding the elongated substrate through an infeed control assembly, tensioning the elongated substrate, conveying the elongated substrate and a heat transfer tape through a heat transfer applicator, transferring the graphic onto the substrate and tensioning the elongated substrate through an outfeed control assembly.

CROSS REFERENCE TO RELATED APPLICATION DATA

This application claims the benefit of priority of Provisional U.S. Patent Application Ser. No. 61/298,516, filed Jan. 26, 2010.

### BACKGROUND OF THE INVENTION

The present invention is directed to a system and apparatus for producing text and/or graphics on elongated solid or hollow substrates, such as fabric-covered or rubber-covered substrates such as industrial hose, electrical conduit, packaging, and the like.

Printing text or graphics onto substrates is well known in the art. In many instances, the substrate or item is one that is intended to be used for a long period of time. To this end, the printed indicia (e.g., the manufacturer's name, trademark or the like), should be of high quality, long-lasting, difficult to abrade and resistant to chemical and environmental degradation. Heat transfer tape is a popular choice for providing such high quality graphics on substrates.

Elongated substrates, such as hollow or solid tubes or cylinders, however, require more customized printing methods. One common method for providing graphics or text on, for example, vulcanized industrial hose, is to place and hold heat transfer tape, having a graphic or text printed thereon, in contact with the rubber surface of the hose prior to the vulcanization process. A nylon or polyester fabric material or extruded plastic cover is positioned over both the heat transfer tape and hose, and the entire item is subsequently cured. During the vulcanization/curing process, the graphic from the heat transfer tape is transferred onto the hose under pressure and high temperature such that the resulting product has the graphic imprinted onto the surface of the hose.

While this heat transfer tape method is efficient and produces high quality graphics, if the hose is not of the type to be subject to a wrapping process using, for example, nylon or polyester fabric material or an extruded plastic cover prior to the vulcanization treatment during manufacturing, the above-noted heat transfer process cannot be used.

For elongated substrates which do not require wrapping prior to vulcanization, such as open-cured, fabric-covered hose or other open-cured hose types, wet ink processes are conventionally used to transfer text or graphics to the surface of the hose. If the text or graphic is to be repeated along the length of the hose, however, the wet ink can be subject to smearing as the hose is indexed to a next position, diminishing print quality.

Another method uses hot foil stamping. However, both of these processes, the wet ink and hot foil stamping processes, have their own limitations and are often associated with poor abrasion resistance and low definition graphics.

Accordingly, there is a need for an apparatus and system for applying high quality graphics onto elongated substrates, such as fabric covered and rubber-covered substrates, that are not covered or wrapped during a vulcanization or curing process. Desirably, such an apparatus and method maintains the structural integrity of the hose and prevents the graphic from adhering to unintended portions of the hose and the like. More desirably, the graphic is applied after the curing or vulcanization process.

### BRIEF SUMMARY OF THE INVENTION

A printing apparatus for elongated substrate, such as fabric-covered or rubber-covered cylinders or hoses, in which the elongated substrate is fed through the printing apparatus to print a graphic thereon includes an infeed control assembly for the substrate, an outfeed control assembly for the substrate and a heat transfer applicator to transfer a graphic onto the elongated tubular or solid substrate. In an embodiment, the infeed control assembly includes a set of infeed rollers. The infeed control assembly can includes both an infeed set of rollers and an infeed guide. The graphic can be transferred in a continuous manner along the length of the substrate.

Similarly, the outfeed control assembly includes, in an embodiment, a set of outfeed rollers and can include a set of outfeed rollers and an outfeed guide. The infeed control assembly and/or the outfeed control assembly can include an adjustable tension control. The heat transfer applicator is a set of wheels wherein at least one of the wheels has a circumferential recess formed in an edge (or width) thereof to accommodate the elongated tubular substrate. Such a printing apparatus can produce an elongated substrate having a heat transfer graphic applied thereto.

A method for printing on the elongated hollow or solid substrate includes feeding the elongated substrate to an infeed control assembly, tensioning the elongated substrate, conveying the elongated substrate through a heat transfer applicator, transferring the graphic to the substrate and tensioning the elongated substrate through an outfeed control assembly.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a perspective view of an embodiment of a heat transfer apparatus for providing indicia onto elongated structures in accordance with the principles of the present invention;

FIG. 2 is a front view of the heat transfer apparatus of FIG. 1;

FIG. 3 is a perspective view of the heat transfer wheels of the heat transfer apparatus; and

FIG. 4 is a perspective view of the printing wheels of the heat transfer apparatus.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

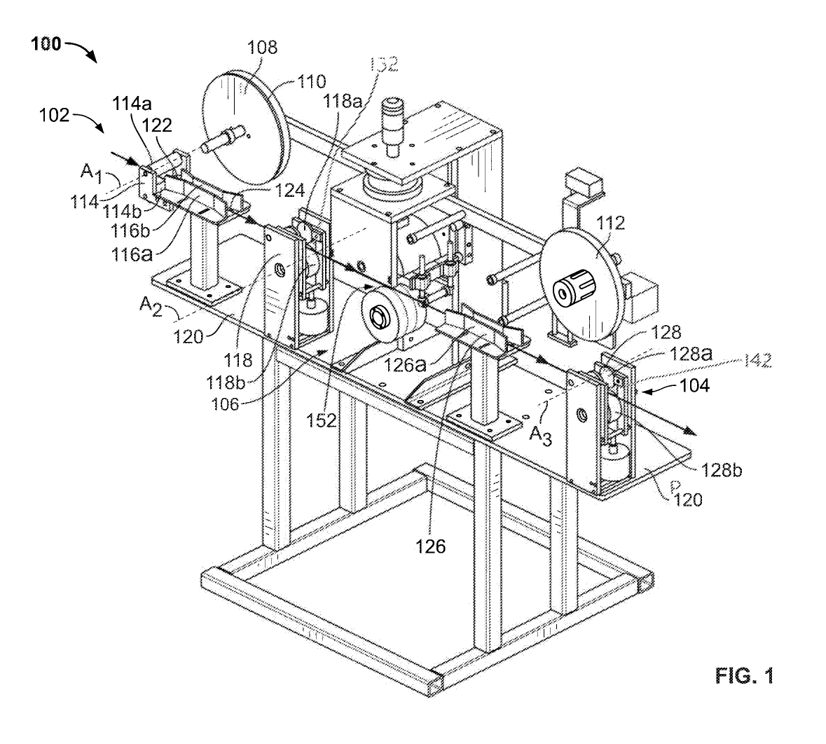

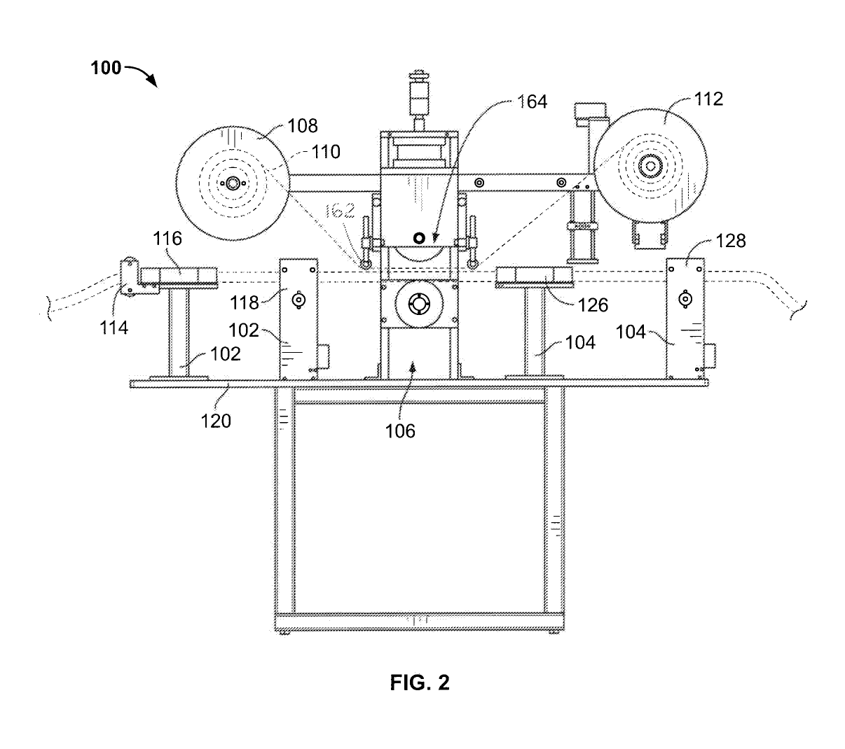

Referring now to the figures and in particular to FIGS. 1 and 2, an embodiment of the present heat transfer apparatus 100 is illustrated. The apparatus 100 includes, generally, an infeed control assembly 102, an outfeed control assembly 104, and a set of heat transfer wheels 106. In addition, the apparatus 100 includes a supply reel 108 having a roll of heat transfer tape or web 110 with a graphic printed thereon, and a take-up reel 112.

In the exemplary embodiment shown in FIGS. 1 and 2, the infeed control assembly 102 includes a first set of infeed rollers 114, an infeed guide 116, and a second set of infeed rollers 118. The first set of infeed rollers 114 includes a first infeed roller 114a and a second infeed roller 114b. The first and second infeed rollers 114a, 114b in the present example are positioned adjacent and parallel to each other, forming a gap 122 therebetween. In one example, a horizontal axis A₁ through the length of the rollers 114a, 114b is parallel to a plane P₁₂₀ defined by the base 120. Alternately, the axis A₁ of the infeed rollers 114a, 114b can be perpendicular or slightly angled with respect to base 120.

The gap 122 between infeed rollers 114a, 114b is adjustable, meaning that it can be narrowed or widened as necessary to accommodate the object onto which the graphic is printed (e.g., the hose). The infeed rollers 114a, 114b may be passive rollers or one or more may be actively driven by an associated motor (not shown).

In an embodiment, the infeed guide 116 includes a first sidewall 116a and a second sidewall 116b, forming a track or path 124 therebetween. The infeed and outfeed regions of the infeed guide 116, in the illustrated embodiment, flare at the ends, as shown in FIG. 1; however, it is also contemplated that the path 124 may be more or less linearly configured. The sidewalls 116a, 116b are adjustable toward and away from one another, such that the track or path 124 formed therebetween can be widened or narrowed, as appropriate.

The second set of infeed rollers 118 includes a first roller 118a and a second roller 118b, positioned adjacent and parallel to each other and forming a gap 132 therebetween. In the illustrated embodiment, an axis A₂ through the length of the rollers 118a, 118b is parallel to the plane P₁₂₀ defined by the base 120. Alternately, the axis A₂ of the infeed rollers 118a, 118b can be perpendicular or slightly angled with respect to the base plane P₁₂₀. The gap 132 between infeed rollers 118a, 118b is also adjustable, so that it can be narrowed or widened as necessary. Adjustment of the rollers 118a,b serves to allow for adjusting the tension in the substrate S. The infeed rollers 118a, 118b may be passive rollers or one or more may be actively driven by an associated motor (not shown).

The outfeed control assembly 104 includes an outfeed guide 126 and at least one set of outfeed rollers 128. The outfeed guide 126 includes a first sidewall 126a and a second sidewall 126b, forming a track or path 134 therebetween. The infeed and outfeed regions of the outfeed guide 126, in a present example, flare at the ends, as shown in FIG. 1; however, it is contemplated that the path 134 may be more or less linearly shaped. The sidewalls 126a, 126b are adjustable toward and away from each other, such that the track or path 134 formed therebetween can be widened or narrowed.

The outfeed rollers 128 include a first roller 128a and a second roller 128b, positioned adjacent and parallel to each other and forming a gap 142 therebetween. In one example, a horizontal axis A₃ through the length of the outfeed rollers 128a, 128b is parallel to the base 120. Alternately, although not shown, the axis of the outfeed rollers can be rotated (the rollers can be rotated) perpendicular or slightly angled with respect to the base plane P₁₂₀. The gap 142 between outfeed rollers 128a, 128b is adjustable, meaning that the gap 142 can be narrowed or widened as necessary to accommodate the object (e.g., the hose) onto which the graphic is printed. Adjustment of the rollers 128a,b serves to allow for adjusting the tension in the substrate S. The outfeed rollers 128a, 128b may be passive rollers or one or more may be actively driven by an associated motor (not shown). It will be appreciated by those with skill in the art that the number and arrangement of infeed and outfeed rollers and infeed and outfeed guides can be varied as desired, and that such variations and other configurations and are within the scope and spirit of the present invention.

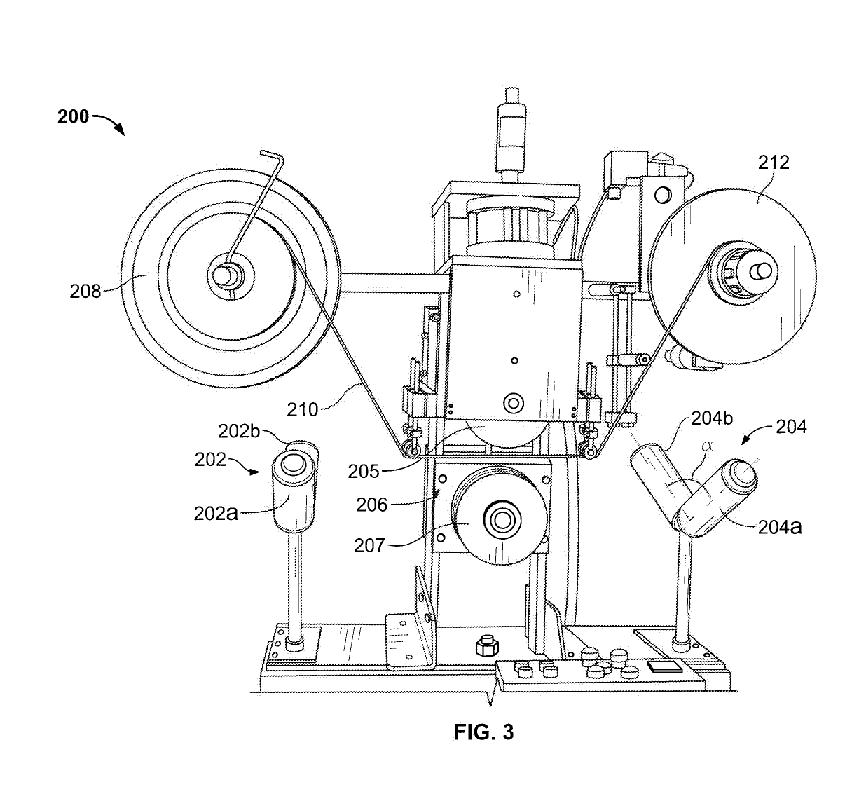

Referring now to FIG. 3, there is illustrated an embodiment of the heat transfer apparatus 200 in which the infeed assembly 202 includes one set of infeed rollers 202a, 202b and the outfeed assembly 204 has one set of outfeed rollers 204a, 204b. The infeed rollers 202a, 202b and the outfeed rollers 204a, 204b are positioned at a slight angle relative to each other and relative to the horizontal, essentially forming a Y or V-shaped region in which the substrate S is received and guided. The arms of the Y or V portions can be rollers to permit smooth, unrestricted movement of the substrate S.

If desired, the angle α between the arms of the infeed and outfeed roller sets 202a, 202b, and 204a, 204b may be adjustable to widen or narrow the angle formed between the rollers. In such an arrangement, the rollers can be positioned in close proximity to the heat transfer wheels 206 such that infeed and outfeed guides may not be used.

It will be appreciated by those with skill in the art that while a preferred embodiment includes such infeed and outfeed guides as described above, other configurations for conveying and aligning are within the scope and spirit of the present invention. Also, it is further contemplated that the infeed and outfeed rollers of either embodiment described above may also include clamps or additional tensioning rollers.

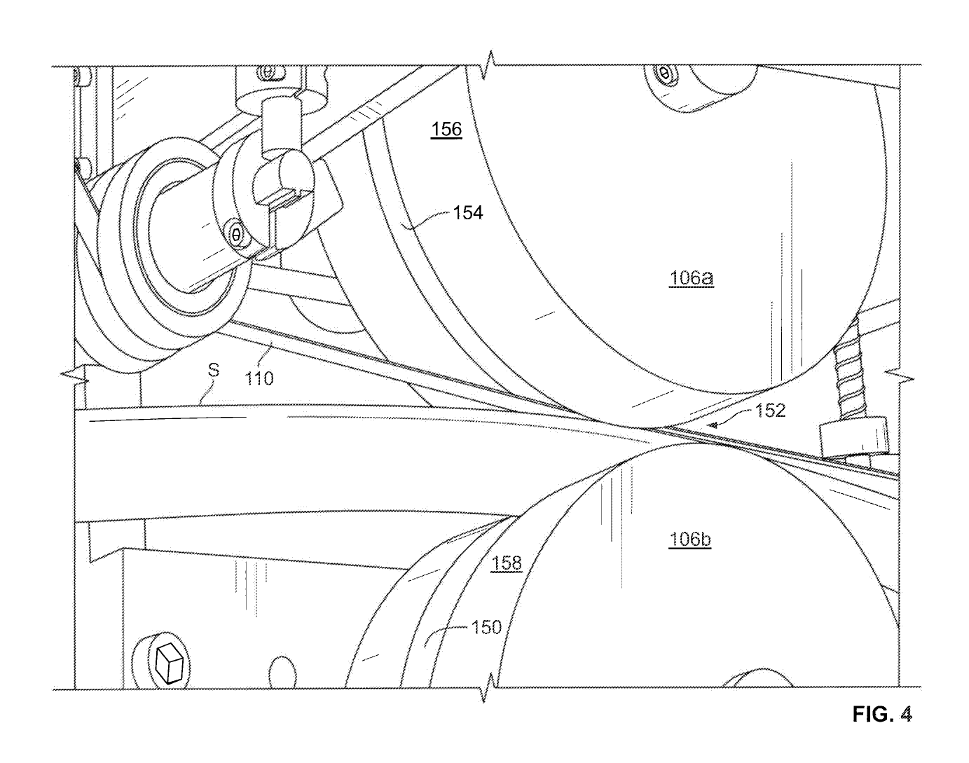

Turning now to FIG. 4, the set of heat transfer wheels 106 includes an upper wheel 106a and a lower wheel 106b, positioned adjacent to one another and forming a nip 152 therebetween. The upper wheel 106a is formed from a metal, ceramic or other material, or combinations thereof, which can be heated without losing its shape or integrity. The upper wheel 106a has a flat or smooth, non-stick surface 154 at the perimeter or circumference 156.

The lower wheel 106b may or may not be heated as well. The lower wheel 106b has a recess 150 formed in the peripheral face of the wheel 106b, around the perimeter or circumference 158 thereof. The recess 150 may be formed by removal of material or may be formed by a build up of material along the perimeter/circumference 158 of the wheel 106b at the outer edges. The recess conforms to the rounded profile of the elongated substrate (e.g. hose) that traverses between the wheels 106a, 106b.

Referring again to FIGS. 1 and 2, the elongated substrate S enters the heat transfer apparatus 100 at infeed rollers 114. The elongated substrate S may include any elongated substrate made from or covered in materials such as plastics, metals, woven and non-woven fabrics, foam, rubber, and the like. The substrate S is conveyed through the infeed guide 116 and through the second set of infeed rollers 118. Each portion of the infeed control assembly 102 serves to tension and grip the substrate S, as well as convey the substrate S, through the apparatus 100 in order to securely hold the substrate S in a desired position for applying the graphic. The substrate S moves from the second set of infeed rollers 118 between the top and bottom heat transfer wheels 106a, 106b at the nip 152.

Simultaneously, the web of heat transfer tape 110, having the graphic to be transferred onto the substrate S, is fed from the supply reel 108.

The heat transfer tape 110 travels around one or more web rollers, shown generally at 162 and enters the printing area, shown generally at 164, between the top and bottom heat transfer wheels 106a, 106b, at nip 152. The graphic on the heat transfer tape 110 is positioned adjacent to the substrate S. The upper wheel 106a moves to apply pressure and heat to the tape 110 and substrate S. The graphic from the heat transfer tape 110 is transferred to the substrate S by use of heat and pressure from the heat transfer wheels, 106a, 106b.

The upper wheel 106a acts as a type of continuously rolling tamp pad. A tamp pad is, typically, an assembly that holds the heat transfer tape 110 and moves the heat transfer tape (with the graphics thereon) into contact with the substrate S onto which the graphics are to be transferred. The upper wheel 106a applies a predetermined or desired force on the tape for a selected period of time to transfer the graphic to the substrate S. The force applied on the tape can be varied depending upon the characteristic of the substrates S, such as rigidness and durability and the characteristics of and type of transfer tape used. A spring or cylinder can be used to facilitate the application of force on the upper wheel 106a and consequently onto the tape 110.

The upper wheel 106a is also heated such that when the upper wheel comes in contact with the heat transfer tape 110 and the substrate S, the upper wheel imparts a predetermined or desired amount of heat in order to facilitate the transfer of the graphic from the heat transfer tape 110 to the substrate S. Such application of heat not only serves to facilitate transfer of the graphic from the heat transfer tape 110, but also serves to firmly adhere the graphic to the substrate S.

The inks and coatings used are compatible with the substrate S material being printed on. For example, an ink having a first chemical composition may adhere better to a fabric material than to a rubber material. And, it will be appreciated by those with skill in the art that an ink used in conjunction with a fabric-covered substrate may be different from that used in for printing onto a rubber-covered substrate and such inks are chosen accordingly. Another ink composition may have characteristics which enable it to better adhere to rubber, and not fabric materials. As such, it will be appreciated by those skilled in the art that an ink composition compatible with the substrate material will preferably be used.

It is desirable to transfer the graphic and apply the graphic to the substrate surface at a relatively high rate of speed. As such, the transfer process inherently controls the throughput of the heat transfer apparatus.

Subsequent to transferring the graphic from the heat transfer tape 110 to the substrate S, the heat transfer tape 110 exits the print area 164 and is accumulated onto a rewind or take-up reel 112 for subsequent disposal, while the newly printed substrate S exits the printing area via the outfeed guide 126 and outfeed rollers 128.

The outfeed guide 126 and outfeed rollers 128 serve two functions: control of substrate movement and cooling of the graphic and/or substrate. The outfeed guide and rollers 126, 128 respectively, firmly hold the substrate S such that the substrate S does not twist and turn upon exiting the print area, thus giving the heated transfer graphic and substrate sufficient time to cool. In addition, the outfeed guide and outfeed rollers 126, 128, may be cooled (as by having cooling fluid flowing therethrough), to assist in the cooling the substrate S and the graphic applied thereon. In this manner, a heat transfer graphic can be applied to the fabric or rubber elongated substrate S in a continuous manner along a length of the substrate S.

A number of methods are known for controlling the application of the graphic to the product or object surface in order to maintain high rates of throughput. The present method and apparatus utilizes several arrangements for creating the proper tension on the substrate S to facilitates such throughput rates.

In the embodiment of FIGS. 1 and 2, infeed rollers 114, 118 and outfeed rollers 128 are adjustable and can provide a desired, specific tension on the substrate S according to the substrate S diameter and/or length. Similarly, the infeed guide 116 and the outfeed guide 126 are also adjustable to create more or less tension on the substrate S and hold the substrate S firmly in position to prevent the substrate S from twisting and turning during the application of heat and pressure by the heat transfer wheels 106.

Optionally, a clutch is operably connected to the infeed rollers 114, 118 to control the movement of the substrate S. The clutch can be set at a single fixed tension value or variable tension, depending on the diameter and length of the substrate and the amount of substrate at the infeed versus the outfeed of the apparatus 100.

The advantages of the present invention will be appreciated by those skilled in the art. The present invention provides a heat transfer tape and heat transfer apparatus suitable for use on elongated articles made from or covered in materials such as plastics, metals, woven and non-woven fabrics, foam structures, rubber articles, and the like. The printed graphic and adhesive are transferred from the carrier to the article under the influence of both heat and pressure, in a continuous manner to create a high quality, durable graphic on an elongated open-cured or fabric substrate.

All patents referred to herein, are incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A printing apparatus for printing onto an elongated substrate, the elongated substrate being fed through the printing apparatus to print a graphic thereon along a length of the substrate, the printing apparatus comprising:
an infeed control assembly;
an outfeed control assembly; and
a heat transfer applicator to transfer a graphic onto the elongated substrate.

2. The apparatus of claim 1 wherein the infeed control assembly includes a set of infeed rollers.

3. The apparatus of claim 1 wherein the infeed control assembly includes an infeed guide.

4. The apparatus of claim 1 wherein the outfeed control assembly includes a set of outfeed rollers.

5. The apparatus of claim 1 wherein the outfeed control assembly includes an outfeed guide.

6. The apparatus of claim 1 wherein the infeed control assembly includes an adjustable tension control.

7. The apparatus of claim 1 wherein the outfeed control assembly includes an adjustable tension control.

8. The apparatus of claim 1 wherein the heat transfer applicator is a set of wheels wherein at least one of the wheels has a circumferential recess formed in an edge thereof

9. A printing apparatus for elongated substrate, wherein the elongated substrate is fed to the printing apparatus to print a graphic thereon along a length of the substrate, the printing apparatus comprising:
an infeed control assembly including a set of infeed rollers and an infeed guide;
an outfeed control assembly including a set of outfeed rollers and an outfeed guide; and
a heat transfer applicator.

10. The apparatus of claim 9 wherein the infeed control assembly includes an adjustable tension control.

11. The apparatus of claim 9 wherein the outfeed control assembly includes an adjustable tension control.

12. The apparatus of claim 9 wherein the heat transfer applicator is a set of heat transfer wheels and wherein at least one of the heat transfer wheels has a circumferential recess formed in an edge thereof.

13. A method for printing heat transfer graphics on an elongated hollow or solid substrate, the method comprising:
feeding the elongated substrate through an infeed control assembly;
tensioning the elongated substrate;
conveying the elongated substrate and a heat transfer tape through a heat transfer applicator;
transferring a graphic onto the substrate; and
tensioning the elongated substrate through an outfeed control assembly.

14. The method of claim 13 wherein the infeed control assembly includes an adjustable tension control.

15. The method of claim 13 wherein the outfeed control assembly includes an adjustable tension control.

16. The method of claim 13 wherein the heat transfer applicator is a set of heat transfer wheels wherein at least one of the heat transfer wheels has a recessed perimeter.

17. The method of claim 16 including the steps of simultaneously applying heat and pressure onto the heat transfer tape and the substrate.
